(19) United States
(12) Patent Application Publication
(10) Pub. No.: US 2004/0040167 A1
(43) Pub. Date: Mar. 4, 2004

(54) Electric junction box template

(76) Inventor: Matthew R. Hall, Harbor City, CA (US)

Correspondence Address: Irving Keschner, Suite 1150, 21515 Hawthorne Boulevard, Torrance, CA, 90503, US

(21) Appl. No.: 10/233,941

(22) Filed: Sep. 4, 2002

(51) Int. Cl. G01D 21/00

(52) U.S. Cl. 33/528

(57) ABSTRACT

A series of templates having a predetermined shape, the combination of shapes corresponding to the shape of most of the commercially available electrical junction boxes. A selected template is positioned on a surface, temporarily secured to the surface, and an outline along the edges of the template then being formed on the surface. A cutout is formed along the outline on the surface and the cut part removed. The electrical junction box is then secured within the opening formed by the cutout.

### BACKGROUND OF THE INVENTION

1. Field of the Invention

The present invention relates to a template to provide a level and traceable pattern for the proper placement of a junction box on a surface, the template having means for releasably securing the template to the surface.

2. Description of the Prior Art

During a remodeling, electricians are required to mark the appropriate place on sheetrock or other wall materials where junction boxes (referred to in the industry as “old work” junction boxes; for reasons of simplicity, the term “junction boxes” will be used hereinafter) will be located and to cut out the marked area. When measuring for the cutout sections in walls, the electrician in practice has utilized a tape measure to measure the appropriate height of the cut-out, and a junction box to trace the shape to be cut out. A ruler has also been used to trace the cut-out shape.

Due to the time constraints and high cost of labor involved inconstruction projects, there is a great need for a device which will expedite the tracing and level marking of cut-outs on existing walls to accommodate junction boxes.

U.S. Pat. No. 5,222,303 to Jardine discloses a template device to mark where apertures in walls and ceilings for junction boxes should be located. The junction box template is provided by providing a template comprising a first portion having a first free end and a second end defining an aperture which is about or slightly larger than the dimensions of a junction box, the first portion is straight and has a predetermined length so as to allow the aperture to be positioned at a predetermined height above a floor or other horizontal surface.

Although Jardine provides a template for marking walls where junction boxes are to be located, the template is large dimensionally and the aperture used to draw the junction box outline has a fixed shape and dimensions.

Paper templates are available for marking walls where junction boxes are to be located. However, these templates are not stable or accurate when held to the surface and are useful for a limited number of installations. In addition, the paper templates do not have an edge that is easily traced.

What is desired is to provide simple and inexpensive templates for marking surfaces, such as walls, with the outline of a junction box, the templates allowing accurate and level marking of the surfaces and having means for releasably securing the templates to the surface.

### SUMMARY OF THE INVENTION

The present invention provides a series of templates of different shapes and dimensions for marking outlines on a surface enabling electricians to cut out the correct and level pattern from the surface for installation of a junction box or other electric component. The templates have front and back surface and, in a preferred embodiment, two sliding mail fasteners are mounted to the back surface of the templates, the nails extending through the thickness of the template to releasably secure the templates to the surface.

The templates are positioned by the installer and checked for level with the front surface against the surface. The template is then attached to the surface by hammering in the nails for stability. The template outline is then traced on the surface, the template is then removed, the opening is then cut out and the electrical box is then installed in the cut out.

The template of the present invention provides a fast, easy and accurate method for drawing cut-out openings for electrical boxes on surfaces such as drywall, plaster and stucco.

### DESCRIPTION OF THE DRAWINGS

For a better understanding of the present invention as well as other objects and further features thereof, reference is made to the following description which is to be read in conjunction with the accompanying drawing therein:

FIGS. 1-6 illustrate different versions of the template of the present invention;

FIGS. 7(a)-7(f) illustrate the steps for securing an electrical outlet to a wall using the template of the present invention;

FIG. 8 illustrates a fastener used to temporarily mount the template to the surface; and

FIGS. 9-12 illustrate additional template shapes of the present invention.

### DESCRIPTION OF THE INVENTION

FIG. 1 illustrates a first embodiment of the present invention wherein a template 10 is illustrated. Template 10 is a rectangular in shape having top 12, bottom 14, left 16, and right 18 edges. The top edge extends in a first horizontal direction, the right edge has a triangular protrusion 20 at the top, an arc protrusion 22 midway along the right edge 18, the remainder of edge 18 being straight. The bottom edge 14 is straight and the left edge 16 has a triangular protrusion 24 at the bottom, an arc protrusion 26 midway along the left edge 16, the remainder of the edge 16 being straight. Template 10 (and the other templates shown in the drawings) is preferably made of a thin plastic material (although other materials can be used) and has a thickness, typically ⅛ inch, to provide an edge for a marking device, such as a pencil, to trace an outline around the edges.

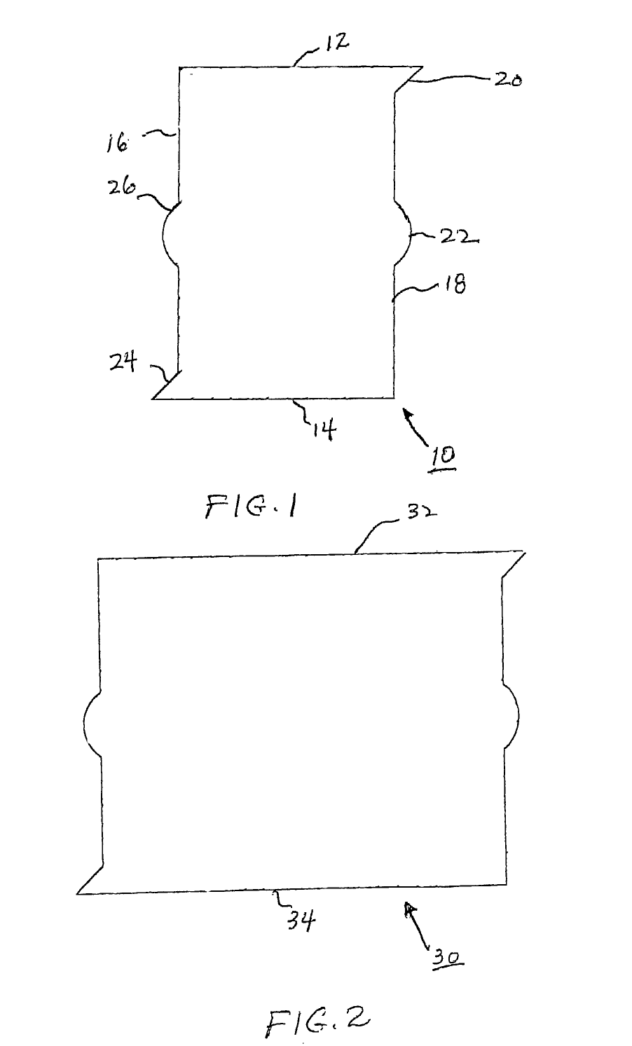

FIG. 2 illustrates a second embodiment of the present invention wherein a template 30 is illustrated. Template 30 is identical to the template shown in FIG. 1 with the exception that the length of the top edge 32 and bottom edge 34 is greater.

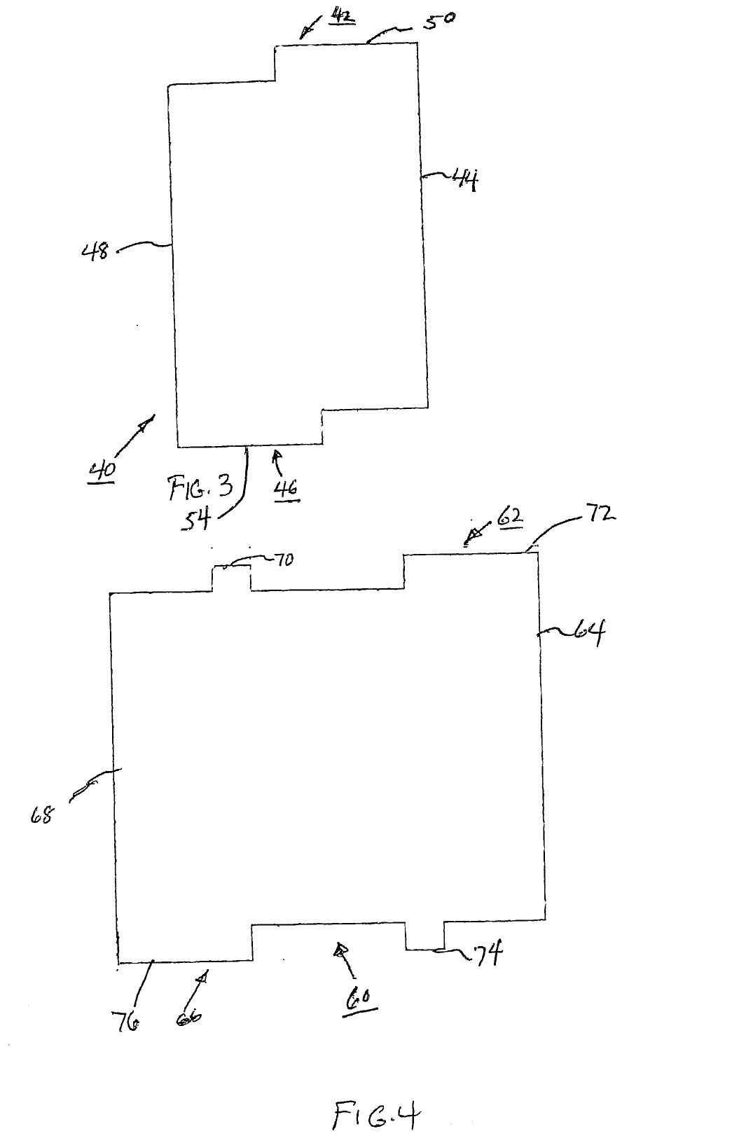

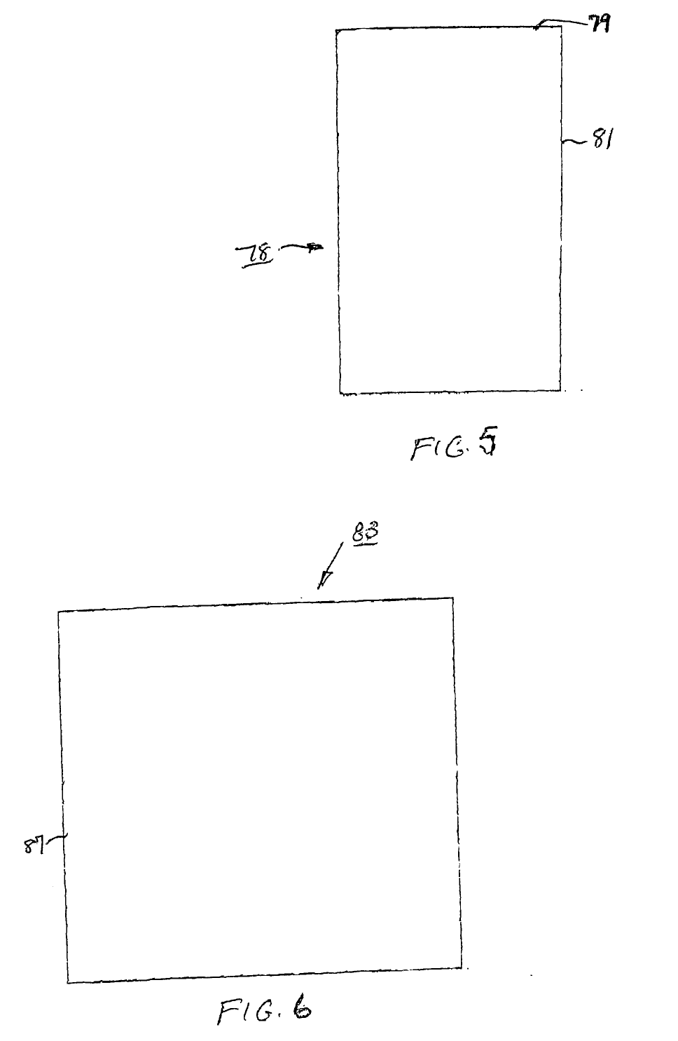

FIG. 3 illustrates a third embodiment of present invention wherein a template 40 is illustrated. Template 40 is rectangular in shape having top, bottom, and left and right edges 42, 44, 46 and 48, respectively. The top edge 42 and bottom edge 46 are shorter than the right edge 44 and left edge 48, the top edge 42 being straight with a step 50 at the right portion as illustrated. The right edge 44 is straight; the bottom edge 46 is straight with a step down 54 on the left portion of the bottom edge 46; the left edge 48 is straight.

Referring now to FIG. 4, a fourth embodiment of the present invention is illustrated. Template 60 is rectangular in shape and has top, bottom, left and right edges 62, 64, 66 and 68, respectively. The top edge 62 and bottom edge 64 are longer than the right edge 64 and left edge 68; the top edge 62 is straight with a rectangular protrusion 70 near the left side and a step portion 72 on the right; the right edge 64 and left edge 68 are straight and the bottom edge 66 is straight with a rectangular protrusion 74 adjacent the right edge and a step down 76 on the left side of the bottom edge.

Referring now to FIG. 5, a fifth embodiment of the present invention is illustrated. Template 78 is essentially rectangular in shape, horizontal edge 79 being shorter than vertical edge 81.

Referring now to FIG. 6, a sixth embodiment of the present invention is illustrated. Template 83 is essentially rectangular in shape, horizontal edge 85 being longer than vertical edge 87.

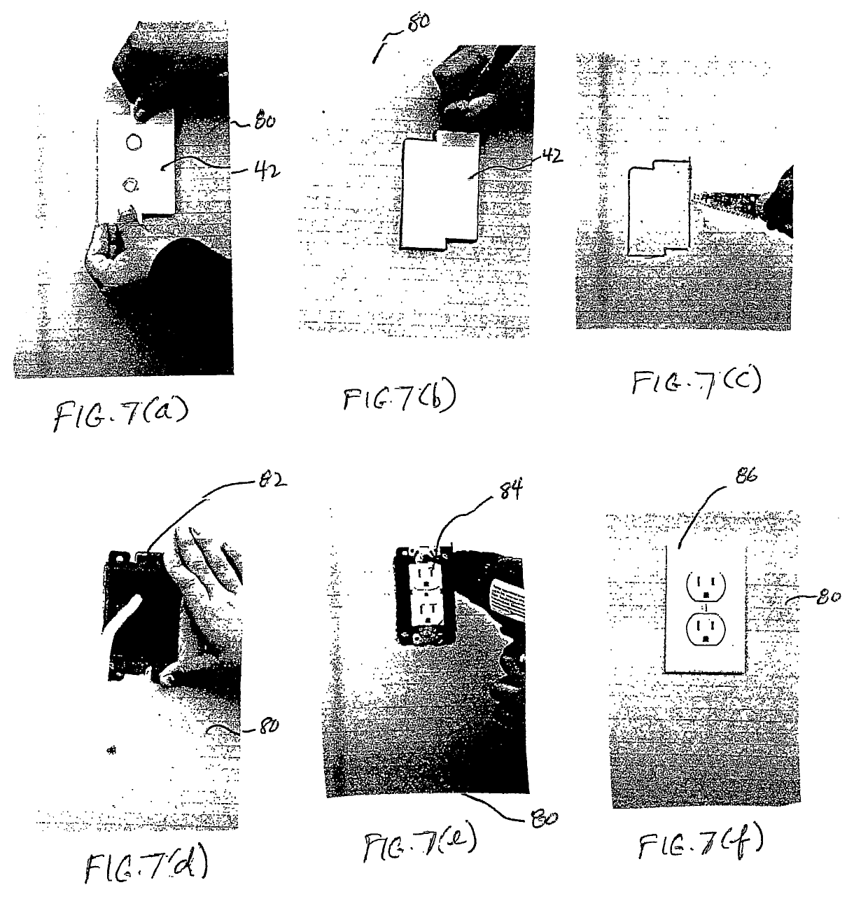

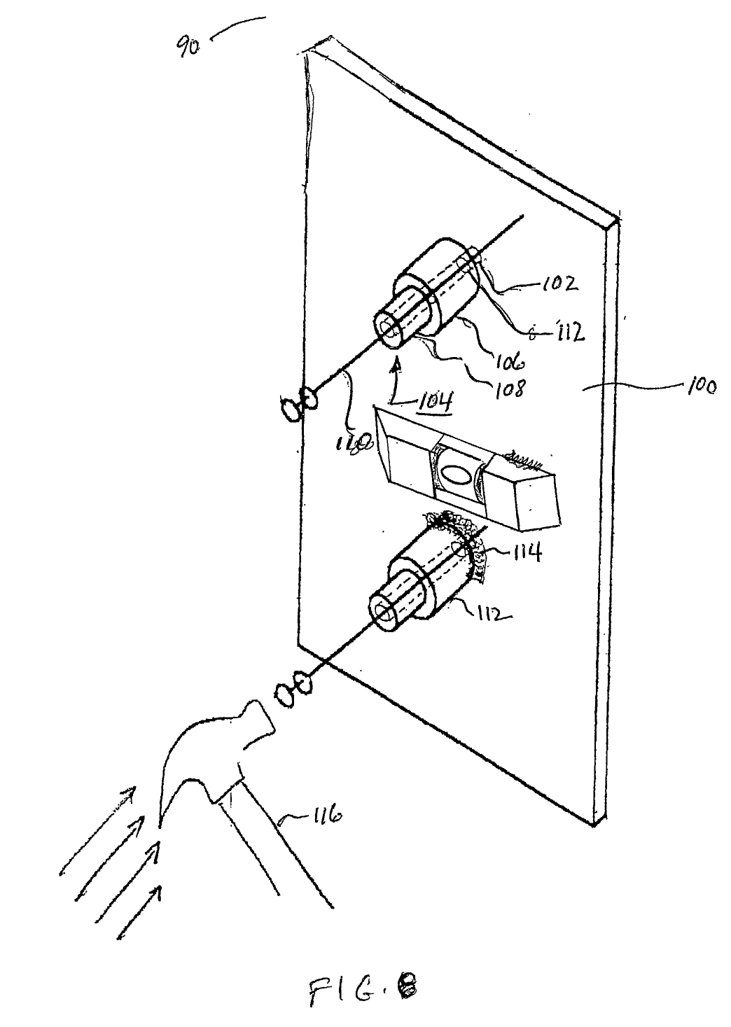

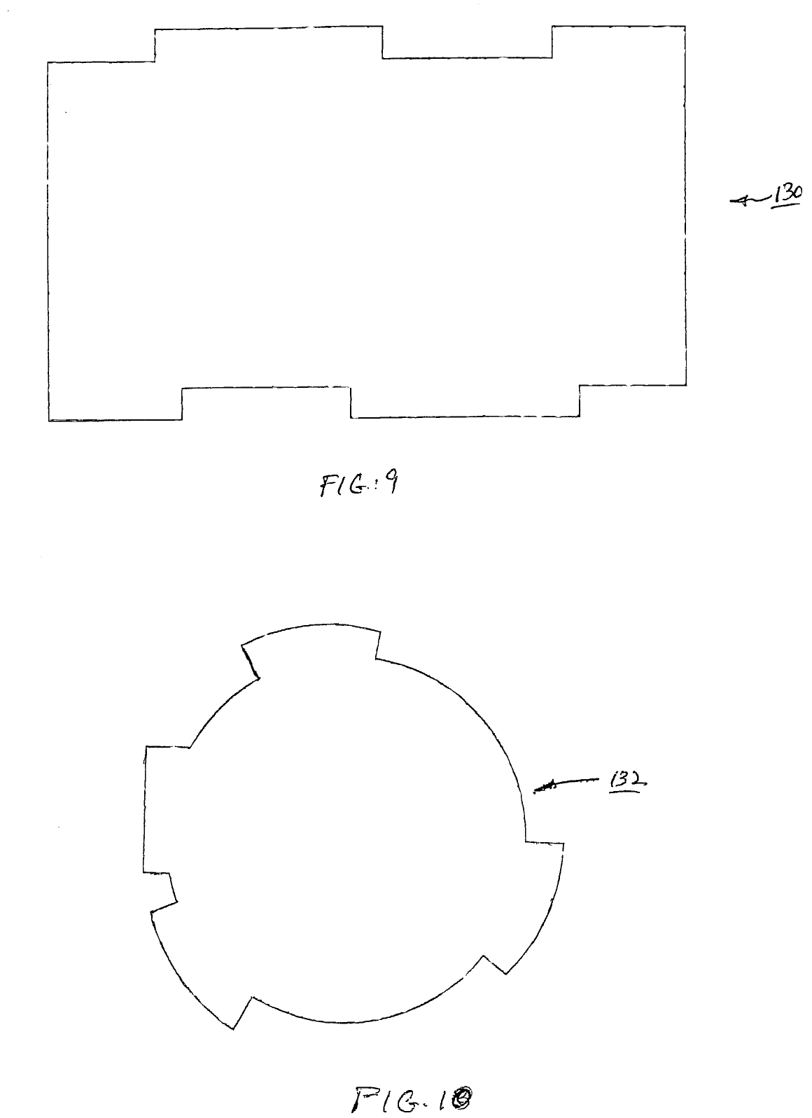

Referring now to FIGS. 7(a)-7(f), FIG. 7(a) illustrates a user securing template 42 to wall (or ceiling) 80. Preferably, template 42 is secured to the wall 80 using the fasteners described with reference to FIG. 8. Alternately, a non-permanent adhesive applied to the surface contacting the surface of wall 80 may be utilized.

FIG. 7(b) shows the user drawing an outline of template 42 on wall 80; FIG. 7(c) illustrates a hole being cut in wall 80 along the outline drawn in FIG. 5(b) with the template 42 removed; FIG. 7(d) shows a junction box 82 positioned in the opening formed after the cutout portion formed on wall 80 is removed; FIG. 7(e) illustrates an outlet terminal 84 being installed in junction box 82 and FIG. 7(f) shows the completed outlet with cover 86 positioned over outlet terminal 84.

FIG. 8 illustrates one technique for releasably mounting a template of the present invention to a surface 90, such as a wall or ceiling. A template 100 (illustrated as being rectangular in shape) has at least one hole 102 formed therethrough. Fastener 104 comprises a cylindrical first base portion 106, a cylindrical second base portion 108 and slidable nail 110. Double headed nail 110 is slidable within base portions 106 and 108 into the wall or ceiling 90 and has a head portion 112 which prevents the nail 110 from being removed from base portions 106 and 108. As shown more clearly in the bottom portion of template 100, an adhesive layer 114 can be applied to the bottom surface of the base portion 112 such that the fastener 104 is secured to the surface of template 100. In use, template 100 is positioned on the wall or ceiling 90, nail 110 is tapped into the surface of template 100 using hammer 116 and the outline of template 100 is then traced with a marker. Nail 110 is then backed out with the hammer 116, template 100 then removed, and the opening is then cut-out on the surface 90, the opening being ready for installation of a junction box. In accordance with a further teaching of the present invention, a conventional bubble level 117 is mounted to the surface 119 of template 100 using an adhesive, such as glue. Level 117 enables the installer to maintain the template 100 level as it is secured to surface 90.

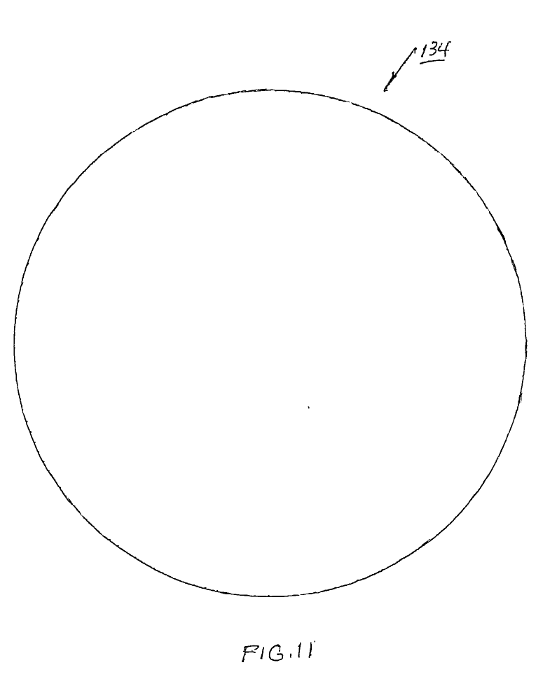

The six templates shown in the FIGS. 1-6 will provide the desired cutout outline for most of the electrical junction boxes currently commercially available (FIGS. 9-12 show other templates 130, 132, 134, and 136, respectively, which can be used with the present invention). The templates are inexpensive to produce and could be easily included in the packaging of the electrical junction boxes to assist the ultimate user in preparing the electrical installation.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. An improved junction box template for use in construction, said template having a predetermined shape having first and second surface, said template allowing for the tracing of a shape of a junction box on a surface, and means for releasably securing said template to said surface.

2. The template of claim 1 wherein said template is fabricated from rigid material.

3. The template of claim 1 wherein said first surface of said template contacts said construction surface.

4. The template of claim 1 wherein said first surface of said template contacts said construction surface, a hole being formed through the thickness of said template.

5. The template of claim 4 wherein said securing means comprises a base member having a first surface and a chamber formed therein, the first surface of said base member being in contact with said construction surface.

6. The template of claim 5 wherein the first surface of said base member has an adhesive formed thereon.

7. The template of claim 5 wherein a nail member secures said template to said surface, said nail member extending through said chamber and said hole into contact with said construction surface.

8. The template of claim 1 wherein said template has leveling means secured thereto.
